(19) United States
(12) Patent Application Publication
(10) Pub. No.: US 2005/0030951 A1
(43) Pub. Date: Feb. 10, 2005

(54) Reservation protocol signaling extensions for optical switched networks

(76) Inventors: Christian Maciocco, Tigard, OR (US); Shlomo Ovadia, San Jose, CA (US)

Correspondence Address: R. Alan Burnett;BLAKELY, SOKOLOFF, TAYLOR & ZAFMAN LLP, Seventh Floor, 12400 Wilshire Boulevard, Los Angeles, CA, 90025-1026, US

(21) Appl. No.: 10/636,062

(22) Filed: Aug. 6, 2003

(51) Int. Cl. H04L 12/28

(52) U.S. Cl. 370/395.2; 370/468

(57) ABSTRACT

An architecture and method for performing coarse-grain reservation of lightpaths within wavelength-division-multiplexed (WDM) based photonic burst-switched (PBS) networks with variable time slot provisioning. The method employs extensions to the RSVP-TE signaling protocol, which uses various messages to reserve resources. A resource reservation request is passed between nodes during a downstream traversal of the lightpath route connecting a source node to a destination node via one or more switching nodes, wherein each node is queried to determine whether it has transmission resources (i.e., a lightpath segment) available during a future scheduled time period. Soft reservations are made for each lightpath segment that is available using information contained in a corresponding label. If all lightpath segments for a selected route are available, a reservation response message is sent back upstream along the route from the destination node to the source node. In response to receiving the response, the soft reservations are turned into hard reservations at each node.

### CROSS REFERENCE TO RELATED APPLICATIONS

The present application is related to U.S. patent application Ser. No. 10/126,091, filed Apr. 17, 2002; U.S. patent application Ser. No. 10/183,111, filed Jun. 25, 2002; U.S. patent application Ser. No. 10/328,571, filed Dec. 24, 2002; U.S. patent application Ser. No. 10/377,312 filed Feb. 28, 2003; U.S. patent application Ser. No. 10/377,580 filed Feb. 28, 2003; U.S. patent application Ser. No. 10/417,823 filed Apr. 16, 2003; U.S. patent application Ser. No. 10/417,487 filed Apr. 17, 2003; U.S. patent application Ser. No. ______ (Attorney Docket No. 42P16183) filed May 19, 2003, U.S. patent application Ser. No. ______ (Attorney Docket No. 42P16552) filed Jun. 18, 2003, and U.S. patent application Ser. No. ______ (Attorney Docket No. 42P16847) filed Jun. 24, 2003

### FIELD OF THE INVENTION

An embodiment of the present invention relates to optical networks in general; and, more specifically, to signaling extensions to the generic multi-protocol label switching (GMPLS) protocol for use within optical burst-switched networks.

### BACKGROUND INFORMATION

Transmission bandwidth demands in telecommunication networks (e.g., the Internet) appear to be ever increasing and solutions are being sought to support this bandwidth demand. One solution to this problem is to use fiber-optic networks, where wavelength-division-multiplexing (WDM) technology enables the same physical link to transport multiple pieces of data concurrently.

Conventional optical switched networks typically use wavelength routing techniques, which require that optical-electrical-optical (O-E-O) conversion of optical signals be done at the optical switches. O-E-O conversion at each switching node in the optical network is not only a very slow operation (typically about ten milliseconds), but it is very costly, and potentially creates a traffic bottleneck for the optical switched network. In addition, the current optical switch technologies cannot efficiently support “bursty” traffic that is often experienced in packet communication applications (e.g., the Internet).

A large communication network can be implemented using several sub-networks. For example, a large network to support Internet traffic can be divided into a large number of relatively small access networks operated by Internet service providers (ISPs), which are coupled to a number of metropolitan area networks (Optical MANs), which are in turn coupled to a large “backbone” wide area network (WAN). The optical MANs and WANs typically require a higher bandwidth than local-area networks (LANs) in order to provide an adequate level of service demanded by their high-end users. Furthermore, as LAN speeds/bandwidth increase with improved technology, there is a corresponding need for increasing MAN/WAN speeds/bandwidth.

Recently, optical burst switching (OBS) schemes have emerged as a promising solution to support high-speed bursty data traffic over WDM optical networks. The OBS scheme offers a practical opportunity between the current optical circuit-switching and the emerging all optical packet switching technologies. It has been shown that under certain conditions, the OBS scheme achieves high-bandwidth utilization and class-of-service (CoS) by elimination of electronic bottlenecks as a result of the O-E-O conversion occurring at switching nodes, and by using a one-way end-to-end bandwidth reservation scheme with variable time slot duration provisioning scheduled by the ingress nodes. Optical switching fabrics are attractive because they offer at least one or more orders of magnitude lower power consumption with a smaller form factor than comparable O-E-O switches. However, most of the recently published work on OBS networks focuses on the next-generation backbone data networks (i.e. Internet wide network) using high capacity (i.e., 1 Tb/s) WDM switch fabrics with a large number of input/output ports (i.e., 256×256), optical channels (i.e., 40 wavelengths), and requiring extensive buffering. Thus, these WDM switches tend to be complex and very expensive to manufacture. In contrast, there is a growing demand to support a wide variety of bandwidth-demanding applications such as storage area networks (SANs) and multimedia multicast at a low cost for both local and wide-area networks.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a simplified block diagram illustrating a photonic burst-switched (PBS) network with variable time slot provisioning, according to one embodiment of the present invention.

FIG. 2 is a simplified flow diagram illustrating the operation of a photonic burst-switched (PBS) network, according to one embodiment of the present invention.

FIG. 3 is a block diagram illustrating a switching node module for use in a photonic burst-switched (PBS) network, according to one embodiment of the present invention.

FIG. 4 is a diagram illustrating a generalized multi-protocol label switching (GMPLS)-based architecture for a PBS network, according to one embodiment of the present invention.

FIG. 5 is a block diagram illustrating GMPLS-based PBS label format, according to one embodiment of the present invention.

FIG. 6 is a schematic diagram illustrating an exemplary set of GMPLS-based PBS labels employed in connection with routing data across a GMPLS-based PBS control network.

FIG. 7 is a block diagram illustrating message flows in connection with RSVP messages.

FIGS. 8a, 8b, and 8c are data structures corresponding to an RSVP-TE-based Path message including extensions to support a coarse-grain resource reservation mechanism in accordance with one embodiment of the invention.

FIG. 9 is a data structure corresponding to a generalized PBS label request object of the Path message data structure of FIG. 8a.

FIGS. 10a, and 10b are data structures corresponding to an RSVP-TE-based Resv message including extensions to support the coarse-grain resource reservation mechanism in accordance with one embodiment of the invention.

FIG. 11 is a data structure corresponding to an RSVP-TE-based PathTear message including extensions to support tear down of resource reservations in accordance with one embodiment of the invention.

FIG. 12 is a data structure corresponding to an RSVP-TE-based ResvTear message including extensions to support tear down of resource reservations in accordance with one embodiment of the invention.

FIG. 13 is diagram illustrating a data structure corresponding to a sender descriptor object and a flow descriptor object that includes a field containing a bandwidth % value used to request reservation of resources supporting a % of the bandwidth provided by such resources.

FIGS. 14a and 14b collectively comprises respective portions of a flowchart illustrating logic and operations performed during a lightpath reservation process, according to one embodiment of the present invention.

FIG. 15 is a diagram illustrating a routing table including possible lightpaths between nodes A and D of FIG. 6.

FIG. 16 is a schematic diagram illustrating components of a Path message employed in an example lightpath reservation process corresponding to FIG. 14a.

FIG. 17a is a diagram illustrating an exemplary resource reservation table hosted by node B of FIG. 6 and containing data used in connection explaining the lightpath reservation process of FIGS. 14a and 14b.

FIG. 17b contains a list of entries from the resource reservation table of FIG. 17a having a time period overlapping the time period of a new reservation request.

FIG. 18 is a schematic diagram illustrating components of a Resv message employed in an example lightpath reservation process corresponding to FIG. 14b.

FIG. 19 is a schematic diagram of a PBS switching node architecture, according to one embodiment of the invention.

### DETAILED DESCRIPTION OF PREFERRED EMBODIMENTS

In the following detailed descriptions, embodiments of the invention are disclosed with reference to their use in a photonic burst-switched (PBS) network. A PBS network is a type of optical switched network, typically comprising a high-speed hop and span-constrained network, such as an enterprise network. The term “photonic burst” is used herein to refer to statistically-multiplexed packets (e.g., Internet protocol (IP) packets or Ethernet frames) having similar routing requirements. Although conceptually similar to backbone-based OBS networks, the design, operation, and performance requirements of these high-speed hop and span-constrained networks may be different. However, it will be understood that the teaching and principles disclosed herein may be applicable to other types of optical switched networks as well.

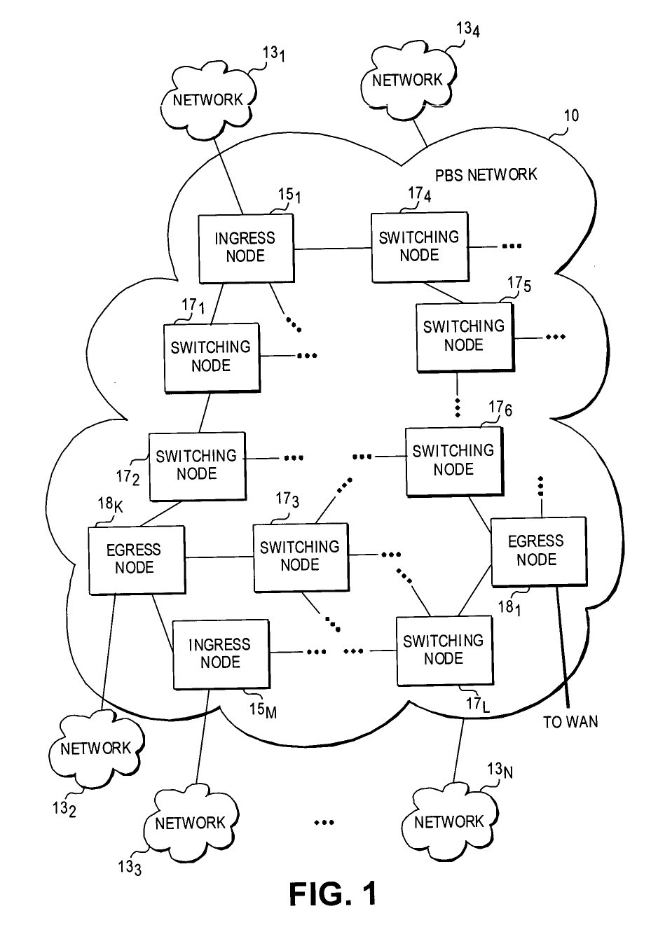

FIG. 1 illustrates an exemplary photonic burst-switched (PBS) network 10 in which embodiments of the invention described herein may be implemented. A PBS network is a type of optical switched network. This embodiment of PBS network 10 includes local area networks (LANs) 13₁-13_{N} and a backbone optical WAN (not shown). In addition, this embodiment of PBS network 10 includes ingress nodes 15₁-15_{M}, switching nodes 17₁-17_{L}, and egress nodes 18₁-18_{K}. PBS network 10 can include other ingress, egress and switching nodes (not shown) that are interconnected with the switching nodes shown in FIG. 1. The ingress and egress nodes are also referred to herein as edge nodes in that they logically reside at the edge of the PBS network. The edge nodes, in effect, provide an interface between the aforementioned “external” networks (i.e., external to the PBS network) and the switching nodes of the PBS network. In this embodiment, the ingress, egress and switching nodes are implemented with intelligent modules. This embodiment can be used, for example, as a metropolitan area network connecting a large number of LANs within the metropolitan area to a large optical backbone network.

In some embodiments, the ingress nodes perform optical-electrical (O-E) conversion of received optical signals, and include electronic memory to buffer the received signals until they are sent to the appropriate LAN. In addition, in some embodiments, the ingress nodes also perform electrical-optical (E-O) conversion of the received electrical signals before they are transmitted to switching nodes 17₁-17_{M} of PBS network 10.

Egress nodes are implemented with optical switching units or modules that are configured to receive optical signals from other nodes of PBS network 10 and route them to the optical WAN or other external networks. Egress nodes can also receive optical signals from the optical WAN or other external network and send them to the appropriate node of PBS network 10. In one embodiment, egress node 18₁ performs O-E-O conversion of received optical signals, and includes electronic memory to buffer received signals until they are sent to the appropriate node of PBS network 10 (or to the optical WAN).

Switching nodes 17₁-17_{L} are implemented with optical switching units or modules that are each configured to receive optical signals from other switching nodes and appropriately route the received optical signals to other switching nodes of PBS network 10. As is described below, the switching nodes perform O-E-O conversion of optical control bursts and network management control burst signals. In some embodiments, these optical control bursts and network management control bursts are propagated only on preselected wavelengths. The preselected wavelengths do not propagate optical “data” bursts (as opposed to control bursts and network management control bursts) signals in such embodiments, even though the control bursts and network management control bursts may include necessary information for a particular group of optical data burst signals. The control and data information is transmitted on separate wavelengths in some embodiments (also referred to herein as out-of-band (OOB) signaling). In other embodiments, control and data information may be sent on the same wavelengths (also referred to herein as in-band (IB) signaling). In another embodiment, optical control bursts, network management control bursts, and optical data burst signals may be propagated on the same wavelength(s) using different encoding schemes such as different modulation formats, etc. In either approach, the optical control bursts and network management control bursts are sent asynchronously relative to its corresponding optical data burst signals. In still another embodiment, the optical control bursts and other control signals are propagated at different transmission rates as the optical data signals.

Although switching nodes 17₁-17_{L} may perform O-E-O conversion of the optical control signals, in this embodiment, the switching nodes do not perform O-E-O conversion of the optical data burst signals. Rather, switching nodes 17₁-17_{L} perform purely optical switching of the optical data burst signals. Thus, the switching nodes can include electronic circuitry to store and process the incoming optical control bursts and network management control bursts that were converted to an electronic form and use this information to configure photonic burst switch settings, and to properly route the optical data burst signals corresponding to the optical control bursts. The new control bursts, which replace the previous control bursts based on the new routing information, are converted to an optical control signal, and it is transmitted to the next switching or egress nodes. Embodiments of the switching nodes are described further below.

Elements of exemplary PBS network 10 are interconnected as follows. LANs 13₁-13_{N} are connected to corresponding ones of ingress nodes 15₁-15_{M}. Within PBS network 10, ingress nodes 15₁-15_{M} and egress nodes 18₁-18_{K} are connected to some of switching nodes 17₁-17_{L} via optical fibers. Switching nodes 17₁-17_{L} are also interconnected to each other via optical fibers in mesh architecture to form a relatively large number of lightpaths or optical links between the ingress nodes, and between ingress nodes 15₁-15_{L} and egress nodes 18₁-18_{K}. Ideally, there are more than one lightpath to connect the switching nodes 17₁-17_{L} to each of the endpoints of PBS network 10 (i.e., the ingress nodes and egress nodes are endpoints within PBS network 10). Multiple lightpaths between switching nodes, ingress nodes, and egress nodes enable protection switching when one or more node fails, or can enable features such as primary and secondary route to destination.

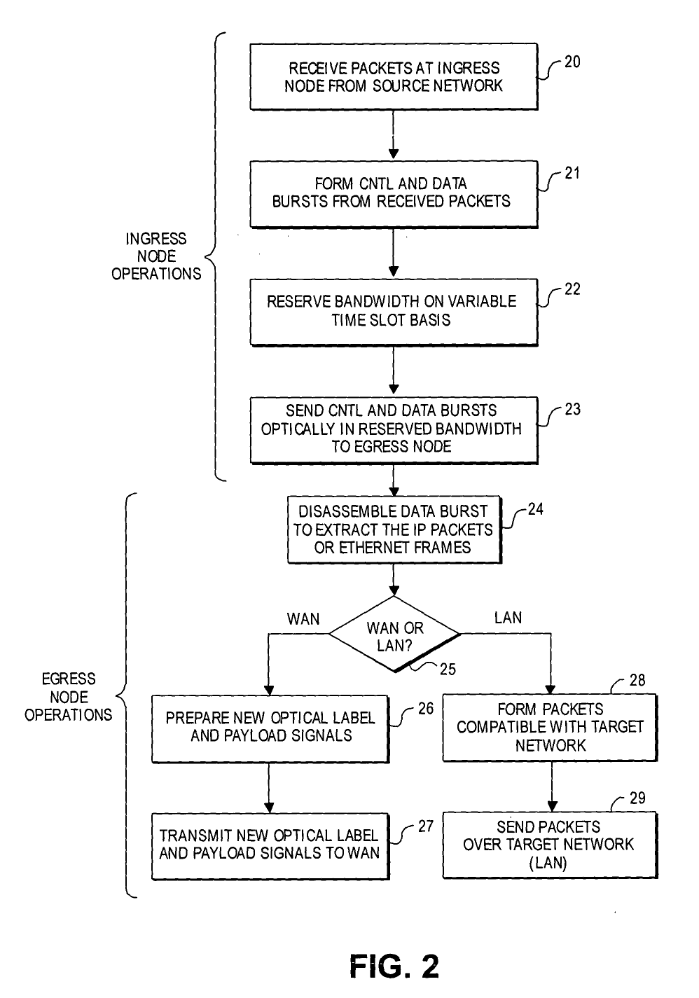

As described below in conjunction with FIG. 2, the ingress, egress and switching nodes of PBS network 10 are configured to send and/or receive optical control bursts, optical data burst, and other control signals that are wavelength multiplexed so as to propagate the optical control bursts and control labels on pre-selected wavelength(s) and optical data burst or payloads on different preselected wavelength(s). Still further, the edge nodes of PBS network 10 can send optical control burst signals while sending data out of PBS network 10 (either optical or electrical).

FIG. 2 illustrates the operational flow of PBS network 10, according to one embodiment of the present invention. Referring to FIGS. 1 and 2, photonic burst switching network 10 operates as follows.

The process begins in a block 20, wherein PBS network 10 receives packets from LANs 13₁-13_{N}. In one embodiment, PBS network 10 receives IP packets at ingress nodes 15₁-15_{M}. The received packets can be in electronic form rather than in optical form, or received in optical form and then converted to electronic form. In this embodiment, the ingress nodes store the received packets electronically.

For clarity, the rest of the description of the operational flow of PBS network 10 focuses on the transport of information from ingress node 15₁ to egress node 18₁. The transport of information from ingress nodes 15₂-15_{M} to egress node 18₁ (or other egress nodes) is substantially similar.

An optical burst label (i.e., an optical control burst) and optical payload (i.e., an optical data burst) is formed from the received packets, as depicted by a block 21. In one embodiment, ingress node 15₁ uses statistical multiplexing techniques to form the optical data burst from the received IP (Internet Protocol) packets stored in ingress node 15₁. For example, packets received by ingress node 15₁ and having to pass through egress node 18₁ on their paths to a destination can be assembled into an optical data burst payload.

Next, in a block 22, Bandwidth on a specific optical channel and/or fiber is reserved to transport the optical data burst through PBS network 10. In one embodiment, ingress node 15₁ reserves a time slot (i.e., a time slot of a TDM system) in an optical data signal path through PBS network 10. This time slot maybe fixed-time duration and/or variable-time duration with either uniform or non-uniform timing gaps between adjacent time slots. Further, in one embodiment, the bandwidth is reserved for a time period sufficient to transport the optical burst from the ingress node to the egress node. For example, in some embodiments, the ingress, egress, and switching nodes maintain an updated list of all used and available time slots. The time slots can be allocated and distributed over multiple wavelengths and optical fibers. Thus, a reserved time slot (also referred to herein as a TDM channel), which in different embodiments may be of fixed-duration or variable-duration, may be in one wavelength of one fiber, and/or can be spread across multiple wavelengths and multiple optical fibers.

When an ingress and/or egress node reserves bandwidth or when bandwidth is released after an optical data burst is transported, a network controller (not shown) updates the list. In one embodiment, the network controller and the ingress or egress nodes perform this updating process using various burst or packet scheduling algorithms based on the available network resources and traffic patterns. The available variable-duration TDM channels, which are periodically broadcasted to all the ingress, switching, and egress nodes, are transmitted on the same wavelength as the optical control bursts or on a different common preselected wavelength throughout the optical network. The network controller function can reside in one of the ingress or egress nodes, or can be distributed across two or more ingress and/or egress nodes.

The optical control bursts, network management control labels, and optical data bursts are then transported through photonic burst switching network 10 in the reserved time slot or TDM channel, as depicted by a block 23. In one embodiment, ingress node 15₁ transmits the control burst to the next node along the optical label-switched path (OLSP) determined by the network controller. In this embodiment, the network controller uses a constraint-based routing protocol [e.g., multi-protocol label switching (MPLS)] over one or more wavelengths to determine the best available OLSP to the egress node.

In one embodiment, the control label (also referred to herein as a control burst) is transmitted asynchronously ahead of the photonic data burst and on a different wavelength and/or different fiber. The time offset between the control burst and the data burst allows each of the switching nodes to process the label and configure the photonic burst switches to appropriately switch before the arrival of the corresponding data burst. The term photonic burst switch is used herein to refer to fast optical switches that do not use O-E-O conversion.

In one embodiment, ingress node 15₁ then asynchronously transmits the optical data bursts to the switching nodes where the optical data bursts experience little or no time delay and no O-E-O conversion within each of the switching nodes. The optical control burst is always sent before the corresponding optical data burst is transmitted.

In some embodiments, the switching node may perform O-E-O conversion of the control bursts so that the node can extract and process the routing information contained in the label. Further, in some embodiments, the TDM channel is propagated in the same wavelengths that are used for propagating labels. Alternatively, the labels and payloads can be modulated on the same wavelength in the same optical fiber using different modulation formats. For example, optical labels can be transmitted using non-return-to-zero (NRZ) modulation format, while optical payloads are transmitted using return-to-zero (RZ) modulation format. The optical burst is transmitted from one switching node to another switching node in a similar manner until the optical control and data bursts are terminated at egress node 18₁.

The remaining set of operations pertains to egress node operations. Upon receiving the data burst, the egress node disassembles it to extract the IP packets or Ethernet frames in a block 24. In one embodiment, egress node 18₁ converts the optical data burst to electronic signals that egress node 18₁ can process to recover the data segment of each of the packets. The operational flow at this point depends on whether the target network is an optical WAN or a LAN, as depicted by a decision block 25.

If the target network is an optical WAN, new optical label and payload signals are formed in a block 26. In this embodiment, egress node 18₁ prepares the new optical label and payload signals. The new optical label and payload are then transmitted to the target network (i.e., WAN in this case) in a block 27. In this embodiment, egress node 18₁ includes an optical interface to transmit the optical label and payload to the optical WAN.

However, if in block 25 the target network is determined to be a LAN, the logic proceeds to a block 28. Accordingly, the extracted IP data packets or Ethernet frames are processed, combined with the corresponding IP labels, and then routed to the target network (i.e., LAN in this case). In this embodiment, egress node 18₁ forms these new IP packets. The new IP packets are then transmitted to the target network (i.e., LAN) as shown in block 29.

PBS network 10 can achieve increased bandwidth efficiency through the additional flexibility afforded by the TDM channels. Although this exemplary embodiment described above includes an optical MAN having ingress, switching and egress nodes to couple multiple LANs to an optical WAN backbone, in other embodiments the networks do not have to be LANs, optical MANs or WAN backbones. That is, PBS network 10 may include a number of relatively small networks that are coupled to a relatively larger network that in turn is coupled to a backbone network.

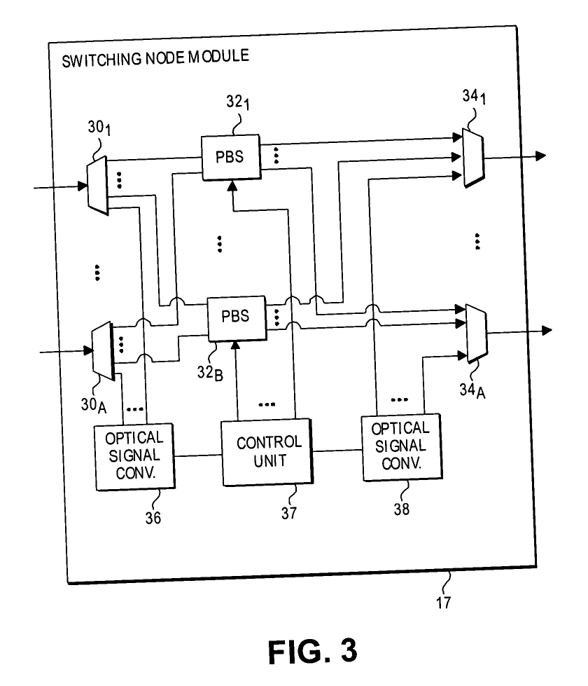

FIG. 3 illustrates a module 17 for use as a switching node in photonic burst switching network 10 (FIG. 1), according to one embodiment of the present invention. In this embodiment, module 17 includes a set of optical wavelength division demultiplexers 30₁-30_{A}, where A represents the number of input optical fibers used for propagating payloads, labels, and other network resources to the module. For example, in this embodiment, each input fiber could carry a set of C wavelengths (i.e., WDM wavelengths), although in other embodiments the input optical fibers may carry differing numbers of wavelengths. Module 17 would also include a set of N×N photonic burst switches 32₁-32_{B}, where N is the number of input/output ports of each photonic burst switch. Thus, in this embodiment, the maximum number of wavelengths at each photonic burst switch is A·C, where N≧A·C+1. For embodiments in which N is greater than A·C, the extra input/output ports can be used to loop back an optical signal for buffering.

Further, although photonic burst switches 32₁-32_{B} are shown as separate units, they can be implemented as N×N photonic burst switches using any suitable switch architecture. Module 17 also includes a set of optical wavelength division multiplexers 34₁-34_{A}, a set of optical-to-electrical signal converters 36 (e.g., photo-detectors), a control unit 37, and a set of electrical-to-optical signal converters 38 (e.g., lasers). Control unit 37 may have one or more processors to execute software or firmware programs. Further details of control unit 37 are described below.

The elements of this embodiment of module 17 are interconnected as follows. Optical demultiplexers 30₁-30_{A} are connected to a set of A input optical fibers that propagate input optical signals from other switching nodes of photonic burst switching network 10 (FIG. 10). The output leads of the optical demultiplexers are connected to the set of B core optical switches 32₁-32_{B} and to optical signal converter 36. For example, optical demultiplexer 30₁ has B output leads connected to input leads of the photonic burst switches 32₁-32_{B} (i.e., one output lead of optical demultiplexer 30₁ to one input lead of each photonic burst switch) and at least one output lead connected to optical signal converter 36.

The output leads of photonic burst switches 32₁-32_{B} are connected to optical multiplexers 34₁-34_{A}. For example, photonic burst switch 32₁ has A output leads connected to input leads of optical multiplexers 34₁-34_{A} (i.e., one output lead of photonic burst switch 32₁ to one input lead of each optical multiplexer). Each optical multiplexer also an input lead connected to an output lead of electrical-to-optical signal converter 38. Control unit 37 has an input lead or port connected to the output lead or port of optical-to-electrical signal converter 36. The output leads of control unit 37 are connected to the control leads of photonic burst switches 32₁-32_{B} and electrical-to-optical signal converter 38.

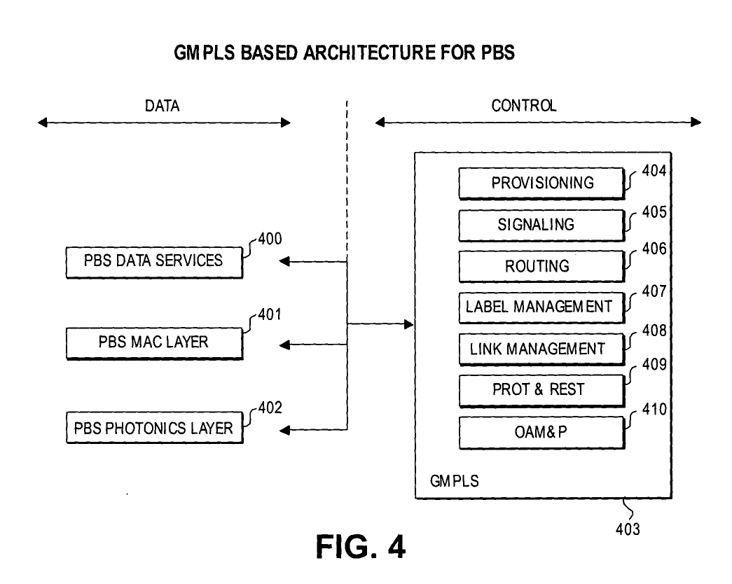

In accordance with further aspects of the invention, a coarse-grained OLSP scheduling mechanism employing signaling extensions to a GMPLS-based framework for a PBS network is provided. An overview of a GMPLS-based control scheme for a PBS network in which the signaling extensions may be implemented in accordance with one embodiment is illustrated in FIG. 4. Starting with the GMPLS suite of protocols, each of the GMPLS protocols can be modified or extended to support PBS operations and optical interfaces while still incorporating the GMPLS protocols' various traffic-engineering tasks. The integrated PBS layer architecture include PBS data services layer 400 on top of a PBS MAC layer 401, which is on top of a PBS photonics layer 402. It is well known that the GMPLS-based protocols suite (indicated by a block 403 in FIG. 4) includes a provisioning component 404, a signaling component 405, a routing component 406, a label management component 407, a link management component 408, and a protection and restoration component 409. In some embodiments, these components are modified or have added extensions that support the PBS layers 400-402. Further, in this embodiment, GMPLS-based suite 403 is also extended to include an operation, administration, management and provisioning (OAM&P) component 410. Further information on GMPLS architecture can be found at http://www.ietf.org/internet-drafts/draft-ietf-ccamp-gmpls-architecture-07.txt. In addition, a functional description of basic GMPLS signaling can be found at http://www.ietf.org/rfc/rfc3471.txt.

In accordance with one aspect of the invention, signaling component 405 can include extensions specific to PBS networks such as, for example, burst start time, burst type, burst length, and burst priority, etc. As described in further detail below, GMPLS signaling extensions are disclosed for enabling reservation scheduling using the RSVP-TE (ReSerVation Protocol-Traffic Engineering) protocol. Link management component 408 can be implemented based on the well-known link management protocol (LMP) (that currently supports only SONET/SDH networks), with extensions added to support PBS networks. Protection and restoration component 409 can, for example, be modified to cover PBS networks. Further information on LMP can be found at http://www.ietf.org/internet-drafts/draft-ietf-ccamp-lmp-09.txt.

Label management component 407 can be modified to support a PBS control channel label space as well. In one embodiment, the label operations are performed after control channel signals are O-E converted. The ingress nodes of the PBS network act as label edge routers (LERs) while the switching nodes act as label switch routers (LSRs). An egress node acts similarly as an egress LER, continuously providing all of the labels of the PBS network. An ingress node can propose a label to be used on the lightpath segment it is connected to, but the downstream node will be the deciding one in selecting the label value, potentially rejecting the proposed label and selecting its own label. A label list can also be proposed by a node to its downstream node. This component can advantageously increase the speed of control channel context retrieval (by performing a pre-established label look-up instead of having to recover a full context). Further details of label configuration and usage are discussed in co-pending U.S. patent application Ser. No. ______ (Attorney Docket No. 42P16847).

To enable PBS networking within hop and span-constrained networks, such as enterprise networks and the like, it is advantageous to extend the GMPLS-based protocols suite to recognize the PBS optical interfaces at both ingress/egress nodes and switching nodes. Under the GMPLS-based framework, the PBS MAC layer is tailored to perform the different PBS operations while still incorporating the MPLS-based traffic engineering features and functions for control burst switching of coarse-grain (from seconds to days or longer) optical flows established using a reservation protocol and represented by a PBS label.

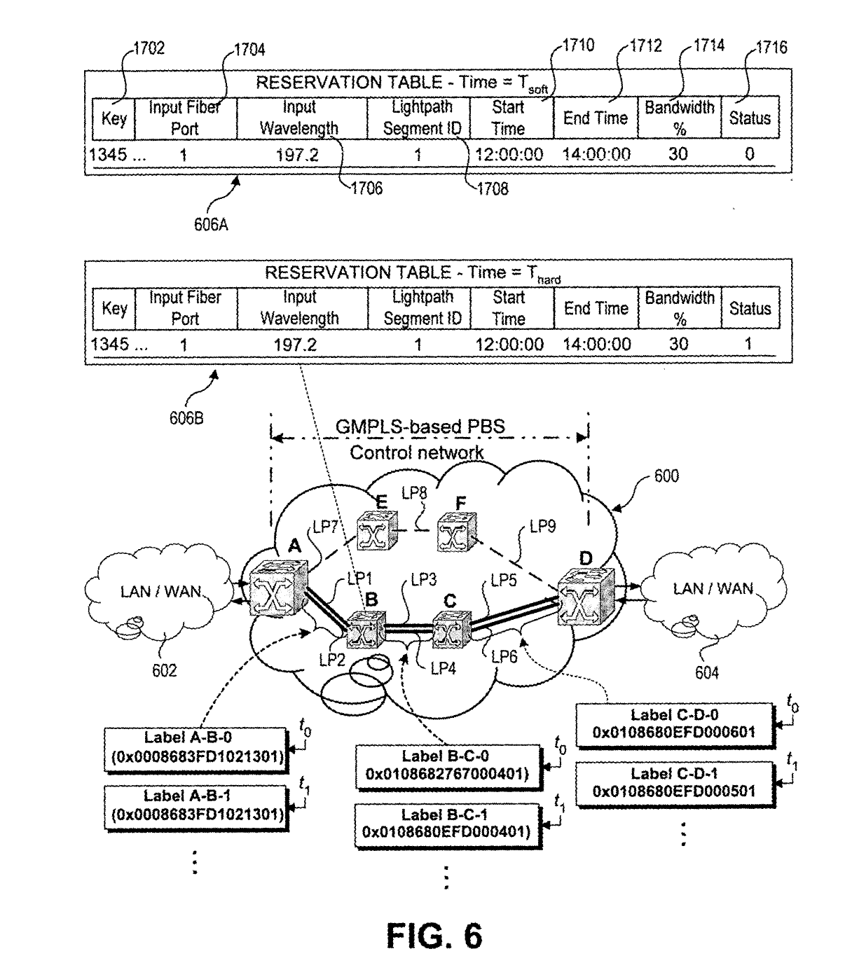

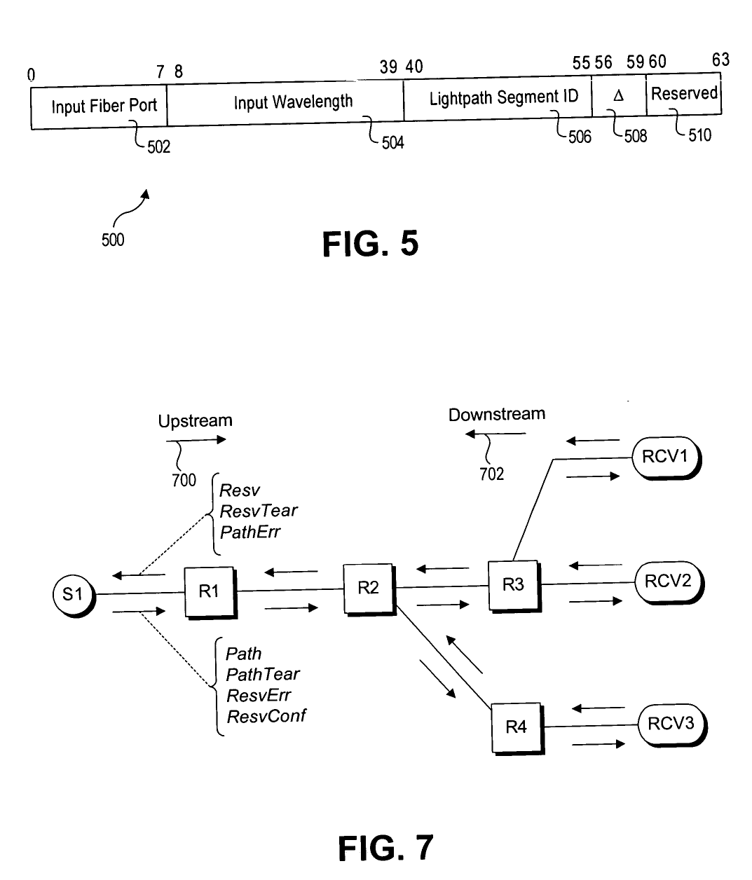

In important aspect of the present invention pertains to label signaling, whereby coarse-grain lightpaths are signaled end-to-end and assigned a unique PBS label. The PBS label has only lightpath segment significance and not end-to-end significance. In exemplary PBS label format 500 is shown in FIG. 5 with its corresponding fields, further details of which are discussed below. The signaling of PBS labels for lightpath set-up, tear down, and maintenance is done through an extension of IETF (Internet Engineering Task Force) Resource Reservation Protocol-Traffic Engineering (RSVP-TE). More information on GMPLS signaling with RSVP-TE extensions can be found at http://www.ietf.org/rf/rfc3473.txt.

The PBS label, which identifies the data burst input fiber, wavelength, and lightpath segment, optical channel spacing, is used on the control path to enable one to make soft reservation request of the network resources (through corresponding Resv messages). If the request is fulfilled (through the Path message), each switching node along the selected lightpath commits the requested resources, and the lightpath is established with the appropriate segment-to-segment labels. Each switching node is responsible for updating the initial PBS label through the signaling mechanism, indicating to the previous switching node the label for its lightpath segment. If the request cannot be fulfilled or an error occurred, a message describing the condition is sent back to the originator to take the appropriate action (i.e., select another lightpath characteristics). Thus, the implementation of the PBS label through signaling enables an efficient MPLS type lookup for the control burst processing. This processing improvement of the control burst at each switching node reduces the required offset time between the control and data bursts, resulting in an improved PBS network throughput and reduced end-to-end latency.

In addition to the software blocks executed by the PBS control processor, there are several other key components that support PBS networking operations described herein. Link Management component 408 is responsible for providing PBS network transport link status information such as link up/down, loss of light, etc. The component runs its own link management protocol on the control channel. In one embodiment, the IETF link management protocol (LMP) protocol is extended to support PBS interfaces. Link protection and restoration component 409 is responsible for computing alternate optical paths among the various switching nodes based on various user-defined criteria when a link failure is reported by the link management component. OAM&P component 410 is responsible for performing various administrative tasks such as device provisioning.

Additionally, routing component 406 provides routing information to establish the route for control and data burst paths to their final destination. For PBS networks with bufferless switch fabrics, this component also plays an important role in making PBS a more reliable transport network by providing backup route information that is used to reduce contention.

The label signaling scheme of the present invention reduces the PBS offset time by reducing the amount of time it takes to process a signaled lightpath. This is achieved by extending the GMPLS-based framework to identify each lightpath segment within the PBS network using a unique label defined in a PBS label space. The use of a PBS label speeds up the PBS control burst processing by allowing the control interface unit within the PBS switching node, which processes the control burst, to lookup relevant physical routing information and other relevant processing state based on the label information used to perform a fast and efficient lookup. Thus, each PBS switching node has access in one lookup operation to the following relevant information, among others: 1) the address of the next hop to send the control burst to; 2) information about the outgoing fiber and wavelength; 3) label to use on the next segment if working in a label-based mode; and 4) data needed to update the scheduling requirement for the specific input port and wavelength.

Returning to FIG. 5, in one embodiment PBS label 500 comprises five fields, including an input fiber port field 502, an input wavelength field 504, a lightpath segment ID field 506, an optical channel spacing (Δ) field 508, and a reserved field 510. The input fiber port field 502 comprises an 8-bit field that specifies the input fiber port of the data channel identified by the label (which itself is carried on the control wavelength. The input wavelength field 504 comprises a 32-bit field that describes the input data wavelength used on the input fiber port specified by input fiber port field 502, and is described in further detail below. The lightpath segment ID field 506 comprises a 16-bit field that describes the lightpath segment ID on a specific wavelength and a fiber cable. Lightpath segment ID's are predefined values that are determined based on the PBS network topology. The channel spacing field 508 comprises a 4-bit field used for identifying the channel spacing (i.e., separation between adjacent optical channels) in connection with the A variable defined below. The reserved field 510 is reserved for implementation-specific purposes and future expansion.

In one embodiment, the input wavelength is represented using IEEE (Institute of Electrical and Electronic Engineers) standard 754 for single precision floating-point format. The 32-bit word is divided into a 1-bit sign indicator S, an 8-bit biased exponent e, and a 23-bit fraction. The relationship between this format and the representation of real numbers is given by:

$$Value = \{ \begin{matrix}{( - 1 )}^{S} \cdot ( {2}^{e - 127} ) \cdot ( 1 + f ) & normalized , 0 < e < 255 \\ {( - 1 )}^{S} \cdot ( {2}^{e - 126} ) \cdot ( 0 + f ) & denormalized , e = 0 , f > 0 \\ exceptional value & otherwise\end{matrix} \qquad Eq . ( 1 )$$

One of the optical channels in the C band has a frequency of 197.200 THz, corresponding to a wavelength of 1520.25 nm. This channel is represented by setting s=0, e=134, and f=0.540625. The adjacent channel separation can be 50 GHz, 100 GHz, 200 GHz, or other spacing. For 50 GHz channel separation, it can be written as: Δ=0.05=1.6·2⁻⁵ (s=0, e=122, f=0.6). Thus, the frequency of the nth channel is given by:
f(n)=f(1)−(n−1)·Δ Eq. (2)
Thus, according to equation (2), the optical channel frequency is given by n and the specific value of Δ, which can be provided as part of the initial network set-up. For example, using the standard ITU-T (International Telecommunications Union) grid C and L bands, n is limited to 249, corresponding to an optical frequency of 184.800 THz. However, other optical channel frequencies outside the above-mentioned range or other wavelength ranges such as wavelength band around 1310 nm can be also defined using equation (2).

Operation of how PBS label 500 is implemented in a GMPLS-based PBS network 6500 is illustrated in FIG. 6. Network 600, which may comprise one of various types of networks, such as an enterprise network, contains four PBS switching nodes, labeled B, C, E, and F, and two edge nodes labeled A and D. Network 600 is coupled at one end to a LAN or WAN network 602 and a LAN or WAN network 604 at another end, wherein nodes A and D operate as edge nodes. For the following example, it is desired to route traffic from network 602 to network 604. Accordingly, edge node A (i.e., the source node) operates as an ingress node, while edge node D (i.e., the destination node) operates as an egress node.

The various switching nodes B, C, E, and F are coupled by lightpath segments LP1, LP2, LP3, LP4, LP5, LP6, LP7, LP8 and LP9, as shown in FIG. 6. There are also other lightpath segments cross-connecting switching nodes B, C, E, and F, which are not shown for clarity. A lightpath segment comprises an optical connection via optical fibers between any adjacent nodes. A lightpath comprises the optical path traveled between source and destination nodes, and typically will comprises a plurality of lightpath segments. In the illustrated example discussed below, one of the lightpaths between the source node (ingress node A) and the destination node (egress node D) comprises lightpath segments LP1, LP4, and LP6.

As further shown in FIG. 6, exemplary PBS labels A-B-0 and A-B-1 are assigned to the path between nodes A and B at times t₀ and t₁, respectively; labels B-C-0 and B-C-1 are assigned to the path between nodes B and C nodes at times to and t₁; and labels C-D-0 and C-D-1 are assigned to the path between nodes C and D nodes at times t₀ and t₁. For the purpose of simplicity, the lightpath segment ID's for lightpath segments LP1, LP2, LP3, LP4, LP5 and LP6 are respectively defined as 0x000, 0x0002, 0x0003, 0x0004, 0x0005, and 0x0006. In accordance with foregoing aspects of PBS networks, a particular LSP may comprise lightpath segments employing different wavelengths. As such, in the illustrated example label A-B-0 defines the use of an optical frequency of 197.2 THz (0x08683FD1), label B-C-0 defines the use of a frequency of 196.4 THz (0x08682767), and label C-D-0 defines the use of a frequency of 195.6 THz (0x08680EFD). On the way from A to D the signaling packet requests resource reservation on a lightpath segment-by-segment basis (i.e. LP1, LP4, and LP6). For example, edge node A requests resources to create a coarse-grain reservation of a selected lightpath. On the first lightpath segment, switching node B checks if it has sufficient resources to satisfy the request. If it doesn't have the resources, it sends an error message back to the originator of the request to take the appropriate action such as send another request or select another lightpath. If it has enough resources, it makes a soft reservation of these resources, and forwards it to the next switching node, wherein the operations are repeated until the destination node D is reached. When node D receives the soft reservation request, it checks if it can be fulfilled.

In order to support coarse-grain scheduling of OLSP's, a reservation mechanism is implemented that employs extensions to the RSVP-TE protocol. In general, the RSVP-TE protocol is itself an extension of the RSVP protocol, as specified in IETF RFC 2205. RSVP was designed to enable the senders, receivers, and routers of communication sessions (either multicast or unicast) to communicate with each other in order to set up the necessary router state to support various IP-based communication services. RSVP identifies a communication session by the combination of destination address, transport-layer protocol type, and destination port number. RSVP is not a routing protocol, but rather is merely used to reserve resources along an underlying route, which under conventional practices is selected by a routing protocol.

FIG. 7 shows an example of RSVP for a multicast session involving one traffic sender S1, and three traffic receivers, RCV1, RCV2, and RCV3. Upstream messages 700 and downstream messages 702 sent between sender S1 and receivers RCV1, RCV2, and RCV3 are routed via routing components (e.g., switching nodes) R1, R2, R3, and R4. The primary messages used by RSVP are the Path message, which originates from the traffic sender, and the Resv message, which originates from the traffic receivers. The primary roles of the Path message are first to install reverse routing state in each router along the path, and second to provided receivers with information about the characteristics of the sender traffic and end-to-end path so that they can make appropriate reservation requests. The primary role of the Resv message is to carry reservation requests to the routers along the distribution tree between receivers and senders.

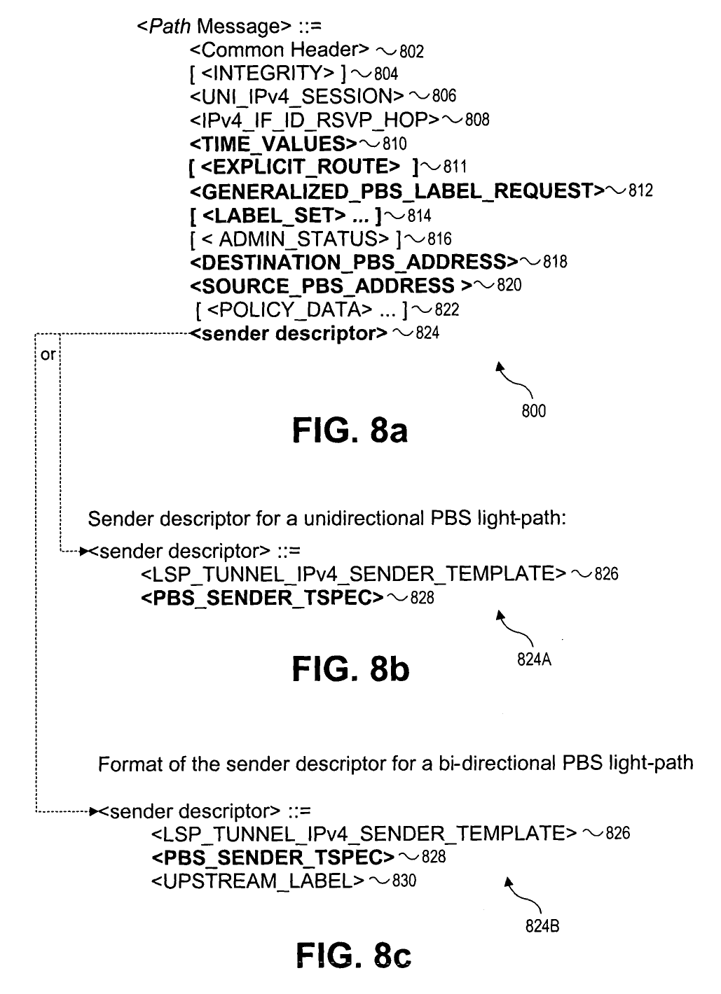

Connection creations requests are issued via a Path message. Details of a Path message 800 with signaling extensions in accordance with an embodiment of the invention is shown in FIGS. 8a-c. For clarity, Path message 800 only shows fields that are pertinent to reservation signaling mechanism described herein; it will be understood that the Path message may further include additional fields specified by the RSVP-TE protocol. Also for clarity, fields that are augmented or added to the standard RSVP-TE data structures are shown in bold. Finally, objects contained in square brackets ([ . . . ]) are optional.

The illustrated objects of Path message 800 include a Common Header 802, an optional Integrity object 804, a Session object 806, an RSVP_Hop object 808, a Time_Values object 810, an optional Explicit_Route object 811, a generalized PBS_Label_Request object 812, an optional Label_Set object 814, an optional Admin_Status object 816, a Destination_PBS_address object 818, a Source_PBS_Address object 820, an optional Policy_Data object 822, and a sender descriptor object 824.

The optional Integrity object 804 carries cryptographic data to authenticate the originating node and to verify the contents of the RSVP message. The Session object 806 contains the IP destination address (Dest Address), the IP protocol ID, and some form of generalized destination port, to define a specific session for the other objects to follow. In one embodiment, the information identifying an Internet Protocol version 4 (IPv4) session, is stored in Session object 806.

RSVP_Hop object 808 carries the IP address of the RSVP-capable node that sent the message (the most recent in the chain of nodes) and a logical outgoing interface handle LIH. RSVP_Hop objects for downstream messages are known as PHOP (“previous hop”) objects, while upstream RSVP_Hop objects are known as NHOP (“next hop”) objects. Thus PHOP RSVP_Hop objects are labeled 808P, while NHOP RSVP_Hop objects are labeled 808N herein.

Under conventional practice, Time_Values object 810 would contain the value for the refresh period used by the creator of the message. However, in accordance with principles of the invention, the object is used to store time values specifying the start and end of an OLSP reservation.

The signaling protocol also supports explicit routing. This is accomplished via the explicit route object 811. This object encapsulates a concatenation of hops that constitute the explicitly routed path. Using the object, the paths taken by label-switched RSVP-MPLS flows can be pre-determined, independent of conventional IP routing. The explicitly routed path can be administratively specified, or automatically compute by a suitable entity based on QoS (Quality of Service) and policy requirements, taking into consideration the prevailing network state. In general, path computation can be control-driven or data-driven. is used to store explicit route data.

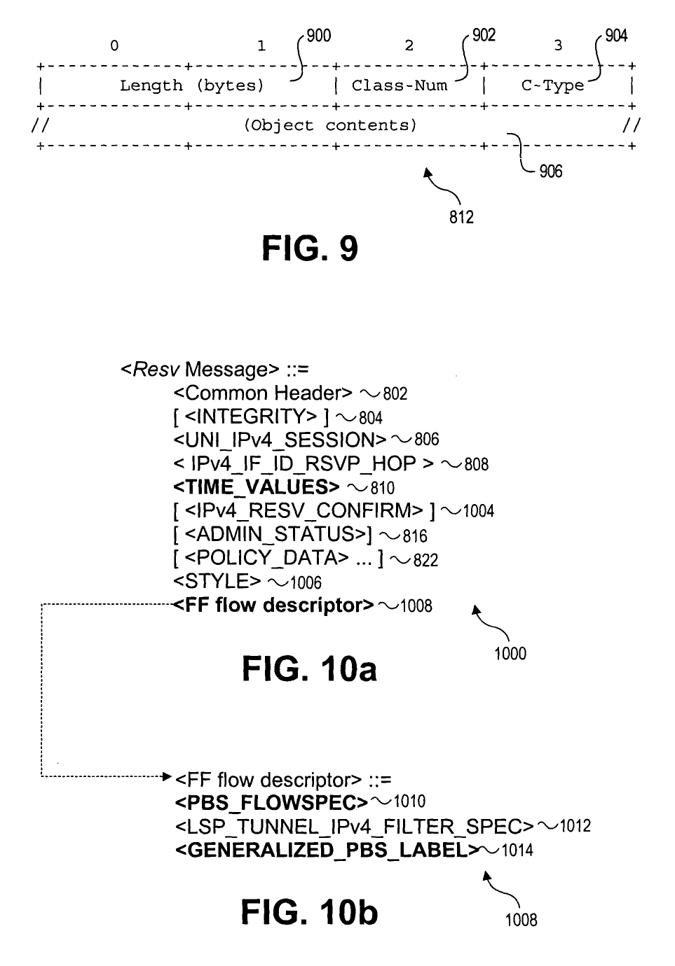

Details of a generalized PBS_Label_Request object 812 format in accordance with one embodiment are shown in FIG. 9. The object's format includes a length field 900, a Class-Num field 902, a C-Type field 904, and object contents 906. The values in both Class-Num field 902 and C-Type field 904 are constants that are standardized once a protocol goes through the standard track. In one embodiment, object contents 906 include a PBS label having a format shown in FIG. 5 and described above.

The Label_Set object 814 is used to limit the label choices of a downstream node to a set of acceptable labels. This limitation applies on a per hop basis. RFC 3271 discusses four cases where a label set is useful in the optical domain. The first case is where the end equipment is only capable of transmitting on a small specific set of wavelengths/bands. The second case is where there is a sequence of interfaces that cannot support wavelength conversion (CI-incapable) and require the same wavelength be used end-to-end over a sequence of hops, or even an entire path. The third case is where it is desirable to limit the amount of wavelength conversion being performed to reduce the distortion on the optical signals. The last case is where two ends of a link support different sets of wavelengths.

The Label_Set object 814 is used to restrict label ranges that may be used for a particular LSP between two peers. The receiver of a Label_Set must restrict its choice of labels to one which are specified in the Label_Set 814. Much like a label, a Label_Set 814 may be present across multiple hops. In this case each node generates its own outgoing Label_Set, possibly based on the incoming Label_Set and the node's hardware capabilities. This case is expected to be the norm for nodes with conversion-incapable (CI-incapable) interfaces. The use of the Label_Set 814 is optional; if not present, all labels from the valid label range may be used. Conceptually the absence of a specific Label_Set object implies a Label_Set object whose value is {U}, the set of all valid labels.

The Admin_Status object 816 is used to notify each node along the path of the status of an LSP. Status information is processed by each node based on local policy and the propagated in the corresponding outgoing messages. The object may be inserted in either Path or Resv messages at the discretion of the ingress (for Path messages) or egress (for Resv messages) nodes.

The Destination_PBS_Address object 818 contains the IP address of the destination node (i.e., the egress node). As discussed above, this information may be provided in the session object; for clarity it is shown as separate data in FIG. 8a. Similarly, the Source_PBS_Address object 820 contains the IP address of the source node (i.e., the ingress node).

Further details of sender descriptor 824 for unidirectional and bi-directional PBS light paths are respectively shown in FIGS. 8a and 8b. FIG. 8a shows a unidirectional sender descriptor 824A that includes a sender template object 826 and a PBS_Sender_TSpec object 828. The bi-directional sender descriptor 824B further includes an upstream label 830 in addition to a sender template object 826 and a PBS_Sender_TSpec object 828.

FIGS. 10a and 10b illustrate the various objects of a Resv message 1000 in accordance with one embodiment. As with conventional RSVP practice, a Resv message is issued by a receiving node in response to a Path message. Accordingly, Resv message 1000 shares many object with Path message 800, including a common header 802, Integrity object 804, Session object 806, RSVP_Hop object 808, Time_Values object 810, Admin_Status object 816, and Policy_Data object 822. In addition, Resv message 1000 a reservation configuration object 1004, a Style object 1006, and a flow descriptor object 1008.

Reservation confirmation object (Resv_Confirm) 1004 holds data that is used to confirm a reservation for a corresponding PBS resource. Further details of resource reservations are described below. Style object 1006 contains data identifying the reservation style, i.e., FF (Fixed Filter—distinct reservation and explicit sender selection), SE (Shared Explicit—shared reservation and explicit sender selection), and WF (Wildcard Filter—shared reservation and wildcard sender selection).

Flow descriptor 1008 contains objects for describing data flows. These objects include a PBS_Flowspec 1010, a Filter_Spec 1012, and a Generalized_PBS_Label 1014.

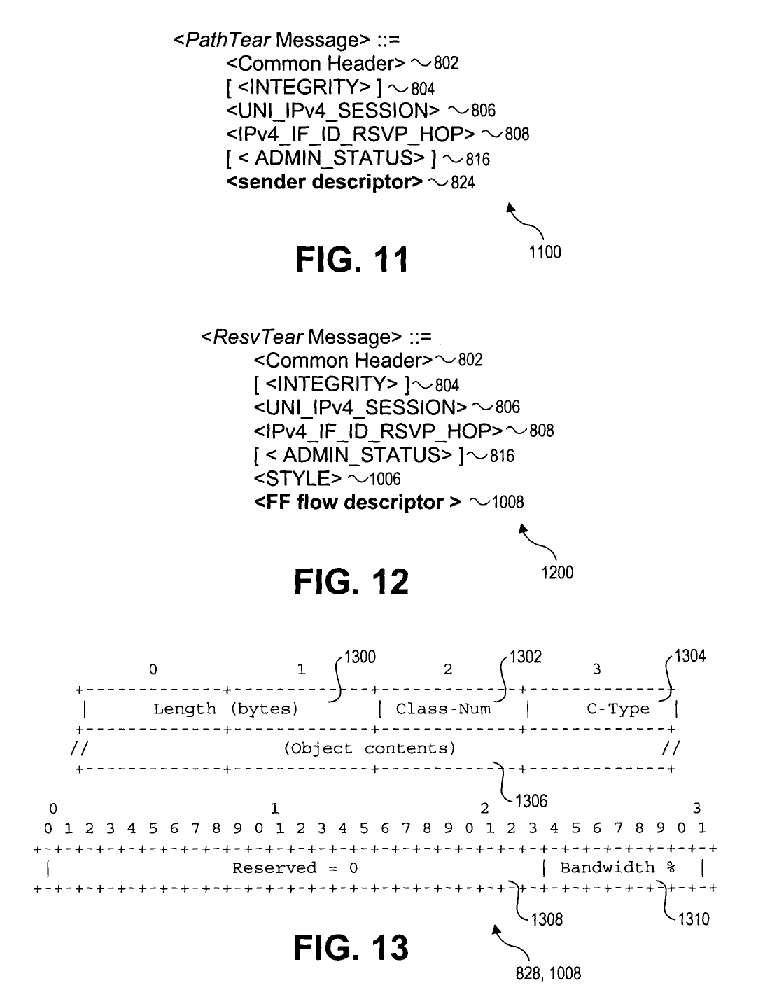

A PathTear message 1100 employed to request the deletion of a connection is shown in FIG. 11. The PathTear message 1100 includes objects that are corollary with Path message 800. These objects include a Common Header 802, an optional Integrity object 804, a Session object 806, an RSVP_Hop object 808, and optional Admin_Status 816, and a sender descriptor 824.

A ResvTear message 1200 issued in response to a PathTear message 1100 is shown in FIG. 12. The ResvTear message 1200 includes a Common Header 802, an optional Integrity object 804, a Session object 806, an RSVP_Hop object 808, and optional Admin_Status 816, a Style object 1006, and a flow descriptor 1200.

A common format is employed for PBS_Sender_TSpec object 828 and PBS_Flowspec object 1010. Each object includes a length field 1300, a Class-Num field 1302, a C-Type field 1304, object contents 1306, a reserved field 1308, and a bandwidth % field 1310. PBS_Send_TSpec objects 828 and PBS_Flowspec objects 1010 can be identified by their respective Class-num/C-Type values. The value in bandwidth % field 1310 represents the amount of bandwidth expressed by the intermediate node as a percent of the available bandwidth on a given lightpath segment. An intermediate node (i.e., a switching node) normalizes this percentage to the available bandwidth of its outgoing link. This enables each of the switching nodes to build-up its bandwidth allocation table for all the incoming label requests and determine if it can satisfy each bandwidth request.

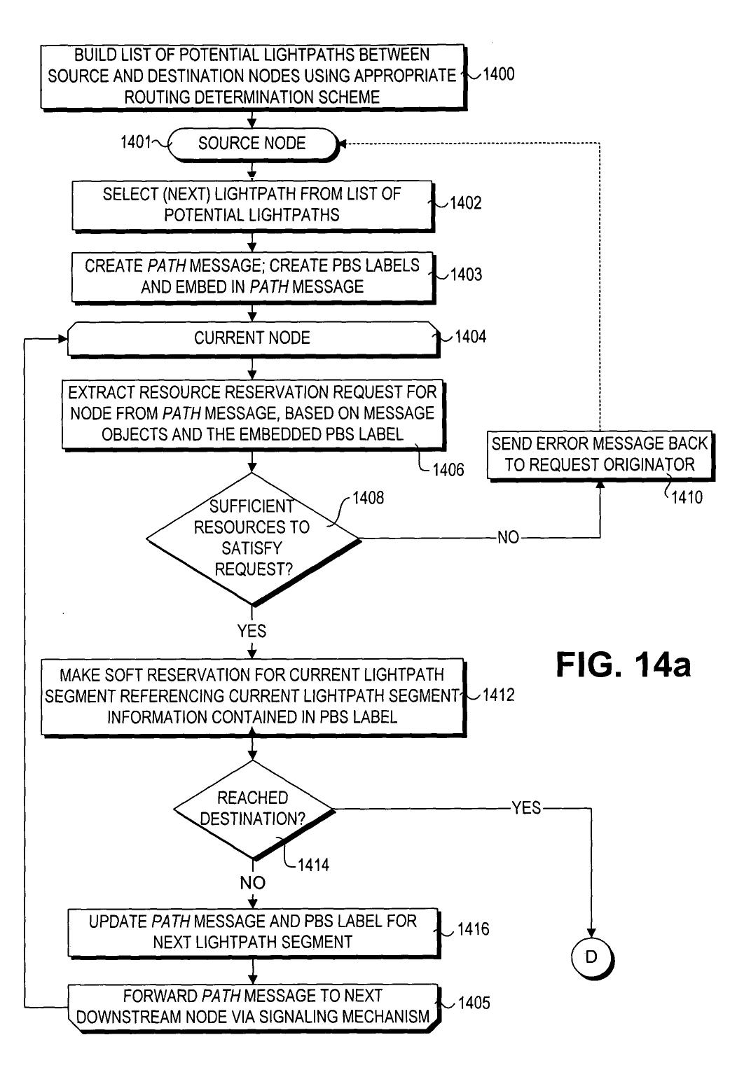

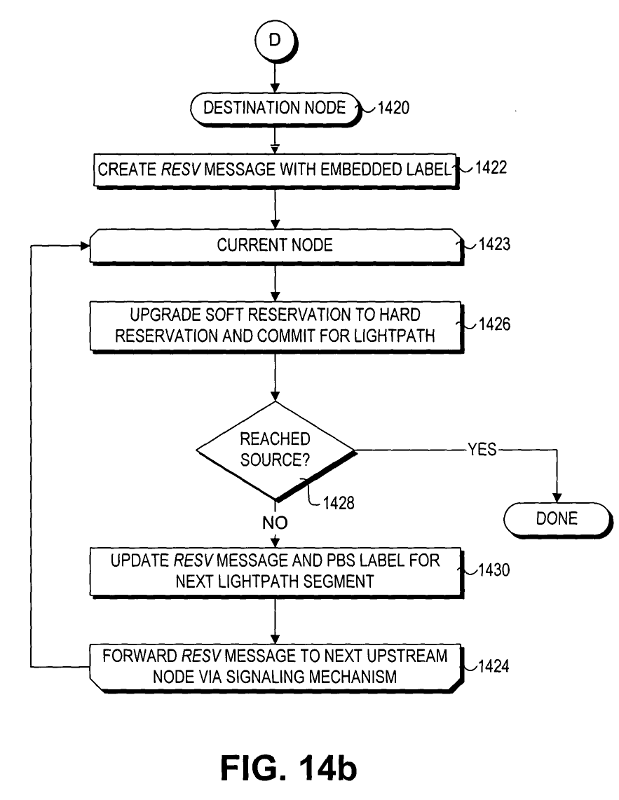

With reference to the flowchart of FIGS. 14a and 14b, operations and logic performed during a PBS label-based lightpath reservation process in accordance with one embodiment of the invention proceeds as follows. The process beings in a block 1400, wherein a list of one or more possible lightpaths between a source node and a destination node defining end points of the OSLP to be scheduled is built. In general, routing components (e.g., routers, switches, etc.) have built-in logic to facilitate automatic route selection. The IP addresses of the source and destination nodes are provided, and one or more routing paths (lightpaths) are determined to route signals between the source and destination nodes, wherein each lightpath comprises a concatenation of hops that constitutes a complete routed path. Such routing information may be stored in a routing table at one or more of the nodes.

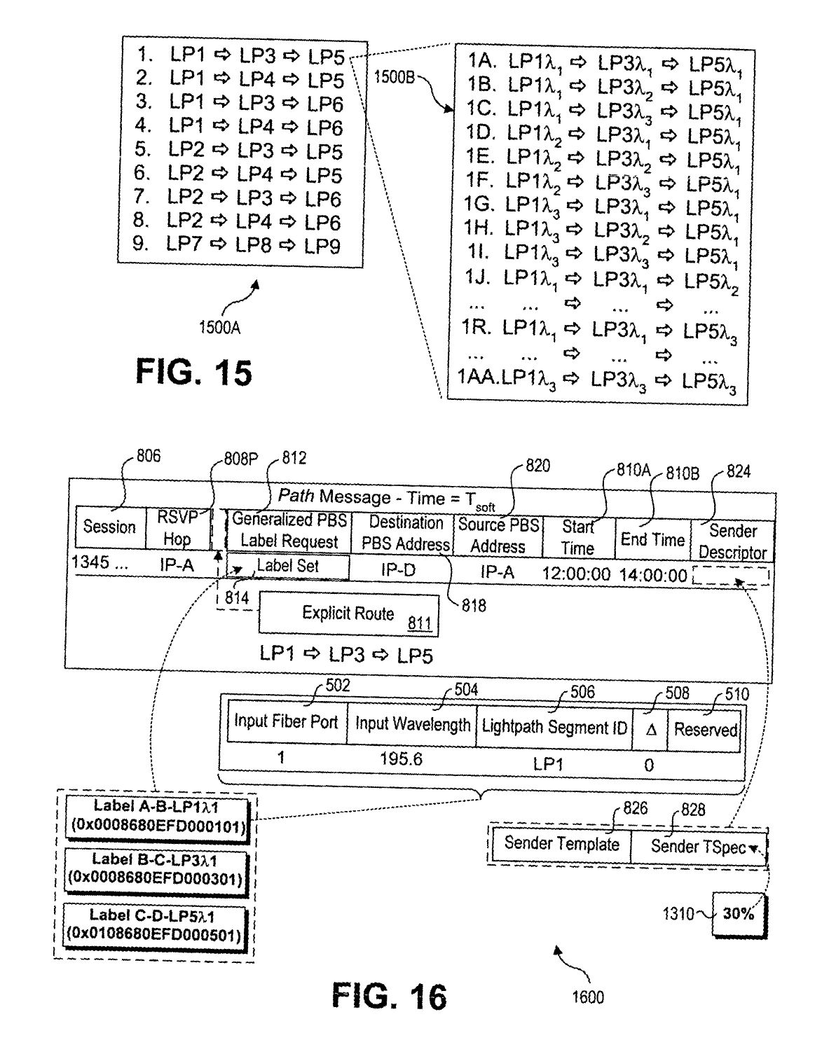

For example, a routing table 1500A in FIG. 15 contains a set of lightpath routes (a.k.a. lightpaths) that support routing of signals between source node A and destination node D of FIG. 6. In this example, a lightpath comprises an ordered set of linked lightpath segments that are to be traversed to complete the route. Routing data, such as that shown in routing table 1500A, may be fixed and determined in advance, or may be determined dynamically. To reduce the size of the routing table, a prioritization algorithm of the various lightpaths in the table may be employed. Specifically, the prioritization algorithm may prioritize lightpaths in the list as a function of one or more specific transmission-related criteria, such as single wavelengths first (i.e., lightpaths in which a single wavelength is used throughout the route) or as a function of the routing availability at the time (e.g., using OSPF (open shortest path first, IETF RFC 1131)). Optionally, a pre-built fixed table containing prioritized lightpaths previously determined by automated means or by an administrator or the like may be employed. Furthermore, the prioritization of the potential lightpaths can be dynamically updated (i.e., reprioritized) if a change in network transmission conditions is detected, such as a change in network topology of if there is a need to balance the traffic loads across the network to achieve a desired performance. For dynamic routing, the IP address of the destination node is provided, and the routing protocol navigates the network topology from the source node to the destination node to determine the best available lightpath routes based on the various lightpath segment combinations that are connected to reach the destination node. In the case of pre-built fixed tables, the ordering of the lightpaths may be determined based on observation of network behavior, e.g., through use statistical traffic data or employing a heuristic traffic prediction algorithm. Lightpath selection techniques of this sort are well-known in the art, so no further explanation of how this operation is performed is included herein.

In accordance with another aspect of the invention, lightpaths may be further delineated based on the wavelengths of the lightpath segments. For example, multiple lightpaths may span the same lightpath segments when transmissions resources employing concurrent wavelengths are supported by one or more of the lightpath segments. In support of this case, entries in routing table 1500A may be expanded to incorporate lightpaths employing the different combination of wavelengths supported by the respective lightpath segments. This is exemplified by entries shown in a routing table 1500B corresponding to lightpath 1 of routing table 1500, wherein each of lightpath segments LP1, LP3, and LP5 support wavelengths λ₁, λ₂ and λ₃.

After one or more lightpaths are determined, the next set of operations concern determining if there are any lightpaths comprising lightpath segments coupled to switching or end nodes that can provide sufficient resources to support traffic based on transmission requirements for a future time period. In the following example, the lightpaths shown in routing table 1500A or (1500B) are evaluated in order, beginning with lightpath 1 (or 1A).

The resource sufficiency determination process begins at the source node, as identified by a start block 1401. In a block 1402, a first potential lightpath is selected from the list built in block 1400. In this example, the first potential lightpath (1A.) contained in routing table 1500B, LP1λ1-to-LP3λ1-to-LP5λ1 is used. Next, in a block 1403, a first Path message is generated, which includes embedded PBS labels for each of the lightpath segments in the lightpath.

FIG. 16 shows details of an exemplary Path message 1600 corresponding to a first pass of the resource reservation process. The destination PBS address 818 contains the IP address of the destination node D, while source PBS address 820 contains the IP address of source node A. Since the most recent node to forward the message is the source node A, RSVP_Hop object 808P contains the IP address for node A.

Information specifying the transmission means for respective lightpath segments along the lightpath route is contained in labels A-B-LP1λ1, B-C-LP3λ1, and C-LP5λ1 stored in label set 814 under generalized PBS label request object 812. Each label includes information identifying an input fiber port for the receiving node (e.g., input fiber port 1 of switching node B), an input wavelength under which data signals will be transmitted on the fiber coupled to the input fiber port (195.6 THz) (it is noted that the input wavelength is actually determined as a function of the values in input wavelength field 504 and A field 508, as discussed above—a specific value is used here for illustrative purposes), and the lightpath segment ID (e.g., LP1) for the lightpath coupled between the sending and receiving nodes.

As discussed above, the reservations to be made comprise coarse-grain time period reservations corresponding to future scheduled uses of virtual network links comprising lightpaths made up of multiple connected lightpath segments. Accordingly, time period data corresponding to Time_Values object 810 comprising a start and end time for a corresponding coarse-grain reservation time period are respectively stored in a start time object 810A and an end time object 810B. For illustrative purposes, the start time depicts 12:00:00 (i.e. 12 noon) and 14:00:00 (i.e., 2:00 PM); in an actual implementation date information would be included as well, either in the same fields or additional fields.

Explicit route information is contained in Explicit_Route object 811. In this instance, the Explicit_Route 811, LP1-to-LP3-to-LP5 specifies the hop-to-hop node address corresponding to light segments, LP1, LP3, and LP5, respectively. The explicit route data are stored in explicit route object 811.

In accordance with aspects of the invention, reservations for the use of lightpath segments used to make up a given lightpath may be defined such that only a partial amount of the channel bandwidth is used. As discussed above, information defining a bandwidth % for the reservation may be stored in bandwidth % field 1310 of sender descriptor object 824. As will be made clear, reservation for resource request that consumes less than or equal to the total available bandwidth for a given resource are accepted, while requests that would consume unavailable bandwidth will be denied.

The next set of operations and logic are performed in a looping manner, as indicated by start and end loop blocks 1404 and 1405, starting at switching node B, which comprises the first closest switching node on the ingress side of the lightpath. The operations defined between start and end loop blocks 1404 and 1405 are performed in an iterative manner for each switching node, until the last lightpath segment has been evaluated for availability. As used herein, the term “current node” identifies that the operations are being performed at a node for which the evaluated lightpath segment is received. The term “next node” represents the next node in the lightpath segment chain. When the logic loops back to start loop block 1404 from end loop block 1405, the next node becomes the current node.

In a block 1406, the Path message is processed at the receiving node to extract a corresponding resource reservation request for the node, based on the Path message objects and the embedded PBS label. For example, at this point switching node B has received a resource reservation request to reserve 30% of the 195.6 THz signal bandwidth for lightpath segment LP1 during coarse-grain time period from 12:00:00 to 14:00:00.

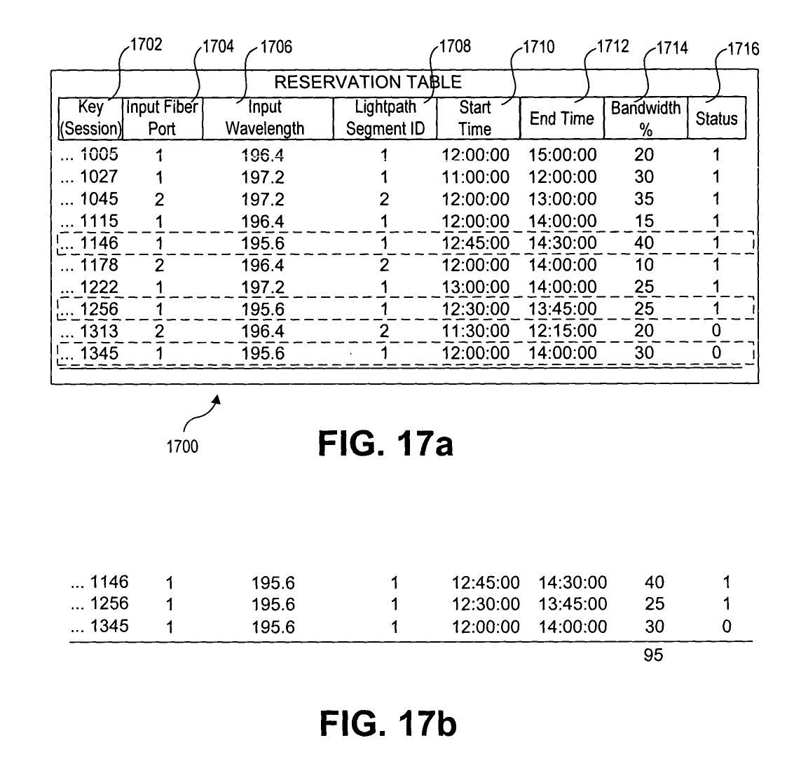

Next, in a decision block 1508, a determination is made by the node to whether it has sufficient resources to satisfy the request. An indication of sufficient resources means that the specified resource (i.e., the bandwidth request at the frequency of for the lightpath segment received at the current node) has not been previously scheduled for use over any portion of the specified time period. In one embodiment, this information may be determined based on resource reservation lookup tables stored at each node, as exemplified by a resource reservation table 1700 shown in FIG. 17a. The resource reservation table contains data pertaining to “soft” (requested, but yet to be confirmed) and “hard” (confirmed) reservations for the various transmission resources provided by the node. This data is stored in several columns, including an optional key column 1702, an input fiber port column 1704, an input wavelength column 1706, a lightpath segment ID column 1708, a start time column 1710, and end time column 1712, a bandwidth % column 1714, and a reservation status (status) column 1716.

Key column 1702 stores a key for each table record. In one embodiment, the key contains information corresponding to the session object 806 of the Path message. In another embodiment, the key is derived from a combination of data in fields corresponding to the PBS label (i.e., in input fiber port column 1704, input wavelength column 1706, and lightpath segment ID column 1708). This enables quick lookup of reservation entries in response to processing control bursts containing specific PBS resource allocation requests.

The input fiber port, input wavelength, and lightpath segment ID are respectively stored in input fiber port column 1704, input wavelength column 1706, and lightpath segment ID column 1708. The start time for the requested (and previously confirmed) time period is stored in start time column 1710, while the corresponding end time period is stored in end time column 1712. The bandwidth % for the request, as well as previously allocated bandwidth %'s, are stored in bandwidth % column 1714. Status bits identifying unconfirmed (0) and confirmed (1) reservations are stored in reservation status column 1716.

In one aspect, resource availability is determined based on the bandwidth availability for the requested lightpath segment, input wavelength, and time period. For example, FIG. 17b shows entries in resource reservation table 1700 corresponding to the current resource request. As can be seen, the previous allocated bandwidth for the requests time period is 65% (40%+25%). It is noted that any entry with a time period overlapping the requested time period and having similar parameters to the requested resource is considered. The bandwidth percent of the entries is aggregated, along with the requested bandwidth. If the sum of the bandwidth exceeds a selected threshold value (e.g., 100%) within the same start and end times, there are inadequate resources to satisfy the request, resulting in a NO answer to decision block 1408. In response, the logic proceeds to a block 1510 in which an error message (e.g., ResvErr) is sent back to the originator of the request (i.e., the source node). In addition to 100%, the threshold may be set to allow under- and over-provisioning of the resource.

If there are sufficient resources to satisfy the reservation request, the logic proceeds to a block 1414 in which a soft reservation is made for the current lightpath segment. In one embodiment, the soft reservation is stored in the reservation table by setting the status bit for the new entry to a “0”. Under the current example, the answer to decision block 1408 would be YES for a 100% threshold.

Next, a determination is made in a decision block 1414 to whether the destination node has been reached. If it has, the logic proceeds to the next portion of the flowchart illustrated in FIG. 14b. If it has not, the logic proceeds to a block 1416, wherein the Path message and embedded PSB label to be employed for the next node are updated for the next lightpath segment. The applicable label will now reference the lightpath segment ID for the next lightpath segment in the lightpath route, including new input fiber port and wavelength values, if applicable. The RSVP_Hop object 808 of the Path message will be updated to reflect that node B is now the PHOP node.

The resource reservation request containing the updated label is then forwarded to the next downstream node via the signaling mechanism in accordance with end loop block 1405. As discussed above, the operations in blocks 1406, 1408, 1410, 1412, 1414, and 1416 are then repeated, as appropriate, in an iterative manner until the destination node is reached, resulting in a YES result for decision block 1415. In accordance with the example, during the first pass it is verified that switching node B could provide sufficient resources to handle the bandwidth and wavelength λ1 time period request for lightpath segment LP1, so the next set of operations concern resource availability for lightpath segment LP3 at wavelength λ1 received at switching node C. In this case, it is determined that node C doesn't have sufficient resources for the bandwidth and wavelength within the time period request for lightpath segment LP3. Thus, the answer to decision block 1408 is NO, and a PathErr message is sent back to node A indicating that insufficient resources are available (i.e., the route is not available). In response, node A selects the next lightpath (1B.) in routing table 1500B in block 1402 and generates a new Path message and set of PBS labels in block 1403 and resource reservation operations are performed for this new potential lightpath.

During the processing of the new lightpath 1B, it is determined that the resources provide by node C for lightpath segment LP3 at wavelength λ2 are inadequate. A corresponding PathErr message is generated in block 1410 and propagated back to node A, which then selects the next applicable lightpath in routing table 1500B. In one embodiment, node A maintains lightpath segment availability data that tracks whether or not a given lightpath segment is available for the reservation. Accordingly, when appropriate, potential lightpaths in the list may be skipped or given a lower priority if it is known that lightpath segment @ wavelength combinations will not work.

Continuing with the routing table, the next potential lightpath considered is lightpath 1C. In this case, it is determined that node C can provide sufficient resources for lightpath segment LP3 at wavelength λ3, and the downstream portion of the reservation request is completed. It is noted that during this process, soft resource reservation entries are added to the resource reservation tables of both nodes C and D.

Next, we proceed to the portion of the flowchart shown in FIG. 14b, which represents the upstream portion of the reservation request. At this point the current node is the destination node D, as depicted by a start block 1420. As before, operations are repeated for each of the nodes along the selected lightpath, akin to a back-propagation technique; these operations are delineated by start and end loop blocks 1423 and 1424. The operations are performed at each node, in reverse sequence to the downstream traversal of the lightpath using a Resv message that is created in a block 1422.

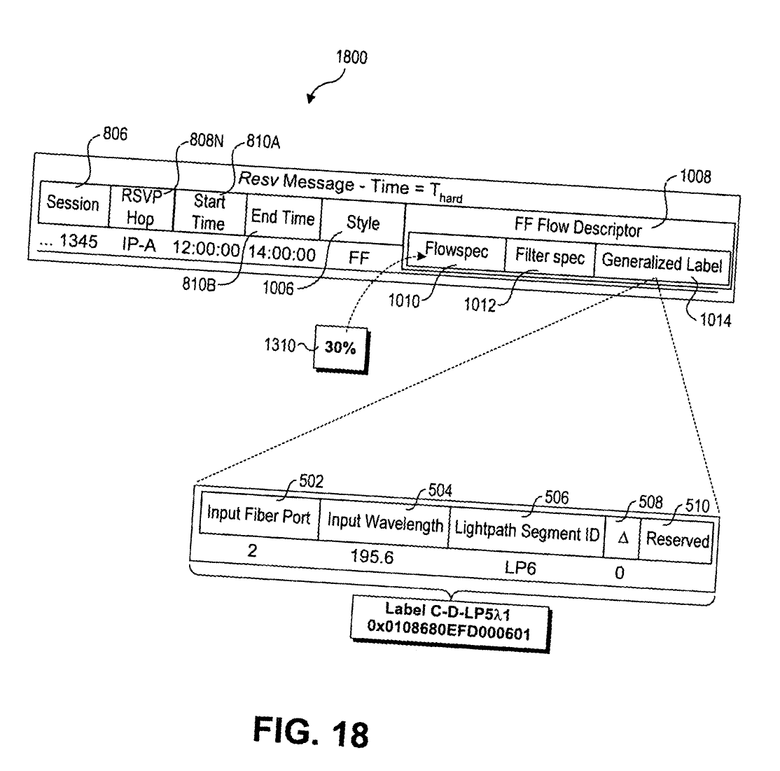

An exemplary Resv message 1800 corresponding to the current state is shown in FIG. 18. Many of the objects contained in Resv message 1800 contain similar values to like-numbered objects contained in Path message 1600, including Session object 806, and start and end time objects 810A and 810B. As discussed above, the Resv message contains a flow descriptor 1008 that includes a PBS_Flowspec 1010, a Filter_Spec 1012, and a Generalized_PBS_Label 1014. In a similar manner to PBS_Sender_TSpec 828 of Path message 1600, PBS_Flowspec 1010 includes a filter field 1310 value of 30%. Also, the Generalized_PBS_Label 1014 will have a form similar to generalized PBS label 500 discussed above. In this instance, the PBS label C-D-0 corresponding to lightpath segment LP6 comprises the first form of the embedded label.

After the initial Resv message is created, the logic proceeds to the looping operation delineated by start and end loop blocks 1423 and 1424. The first operation in the loop occurs in a block 1426, wherein the software reservation for the current node is upgraded to a hard reservation, and the corresponding resources are committed. This is reflected by changing the value in reservation status column 1716 from a “0” (soft, i.e., unconfirmed) to a “1” (hard, i.e., confirmed, meaning the resources are committed).

For example, time-based reservation tables (i.e., time snapshots) 606A and 606B for switching node B are shown in FIG. 6. When the PBS label information is transmitted (e.g., from node A to node D), a soft reservation is made at nodes B, C, and D, as described above. Time instance 606A corresponds to a snapshot of the reservation table at node B is shown in FIG. 6 shortly after a soft reservation has been made. In this case, the reservation status (Status) column 1716 value, which comprises a Boolean value (i.e., status bit), is set to 0, indicating the reservation is not confirmed (i.e., a soft reservation). Time instance 606B corresponds to the change in the table that is made to reservation status column 1716 when the reservation is confirmed on the return path from node D to node A.

Following the operation of block 1426, a determination is made to whether the source node has been reached in a decision block 1428. If it has, the process is completed, and all segments on the lightpath are reserved for a subsequent scheduled use. If not, the process proceeds to a block 1430 in which the Resv message and PBS label are updated for the next lightpath segment. The process then repeats itself for the next (now current) switching node until the source node is reached. At this point, all the nodes along the lightpath will have hard (i.e., confirmed) reservations, and the entire lightpath will be scheduled for use during the indicated timeframe contained in the reservation table.

As further indicated by the labels depicted in FIG. 6, the labels for a given node pair may change over time to reflect a change in the lightpath routing or network topology. Consider the PBS label values for times t₀ and t₁. The PBS labels at to indicate a lightpath route of LP1 to LP4 to LP6, using wavelengths of 197.2 THz, 196.4 THz, and 195.6 THz, respectively. In contrast, at t₁ a portion of the routing path and frequencies have been changed, such that the lightpath route is LP1 to LP4 to LP5, using wavelengths of 197.2 THz, 195.6 THz, and 195.6 THz.

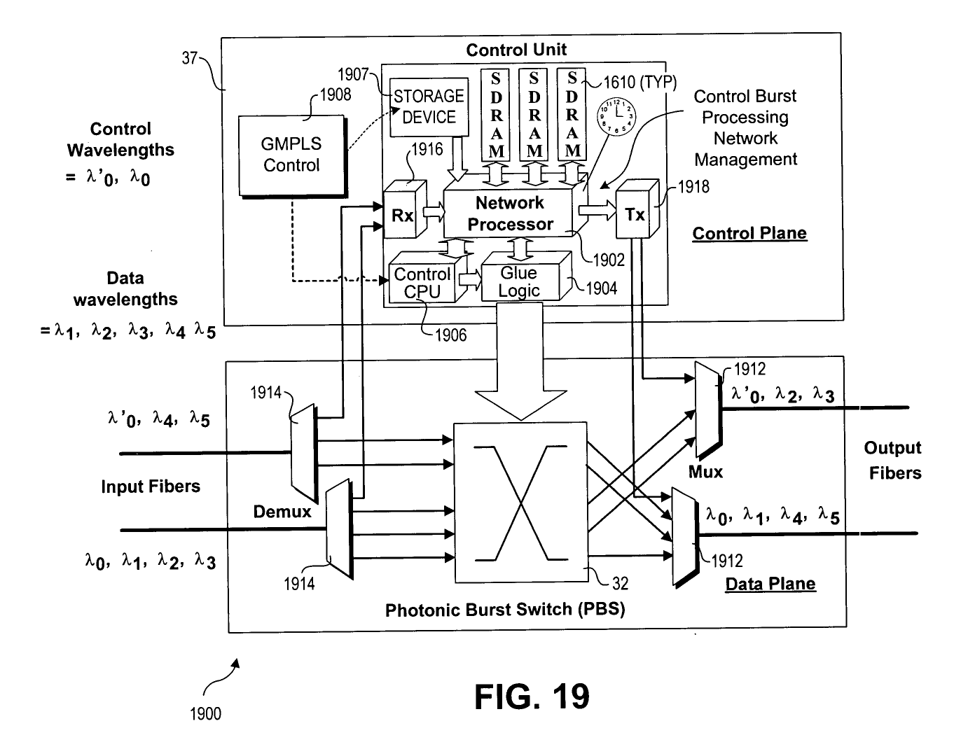

A simplified block diagram 1900 of a PBS switching node architecture in accordance with one embodiment is shown in FIG. 19. The intelligent switching node architecture is logically divided into control plane components and data plane. The control plane includes a control unit 37 employing a network processor (NP) 1902, coupled to glue logic 1904 and a control processor (CPU) 1906 that runs software components stored in a storage device 1907 to perform the resource reservations operations 1908 disclosed herein. Network processor 1902 is also coupled to one or more banks of SDRAM (synchronous dynamic random access memory) memory 1910, which is used for general memory operations. The data plane architecture comprises a non-blocking PBS fabric 32, coupled to optical multiplexers 1912, de-multiplexers 1914, and optical transceivers (as depicted by an optical receiver (Rx) block 1916 and an optical transmitter (Tx) block 1918).

The burst assembly and framing, burst scheduling and control, which are part of the PBS MAC layer and related tasks are performed by network processor 1902. Network processors are very powerful processors with flexible micro-architecture that are suitable to support wide-range of packet processing tasks, including classification, metering, policing, congestion avoidance, and traffic scheduling. For example, the Intel® IXP2800 NP, which is used in one embodiment, has 16 microengines that can support the execution of up to 1493 microengine instructions per packet at a packet rate of 15 million packets per second for 10 GbE and a clock rate of 1.4 GHz.

In one embodiment, the optical switch fabric has strictly non-blocking space-division architecture with fast (<100 ns) switching times and with limited number of input/output ports (e.g., ≈8×8, 12×12). Each of the incoming or outgoing fiber links typically carries only one data burst wavelength. The switch fabric, which has no or limited optical buffering fabric, performs statistical burst switching within a variable-duration time slot between the input and output ports. If needed, the optical buffering can be implemented using fiber-delay-lines (FDLs) on several unused ports, such as taught in L. Xu, H. G. Perros, and G. Rouskas, “Techniques for Optical Packet Switching and Optical Burst Switching,” IEEE Communication Magazine 1, 136-142 (2001). The specific optical buffering architecture, such as feed-forward or feedback, will generally depend on the particular characteristics of the switching node and PBS network in which it is deployed. However, the amount of optical buffering is expected to be relatively small compared with conventional packet switching fabric, since the FDLs can carry multiple data burst wavelengths. Other possible contention resolution schemes include deflection routing and using tunable wavelength converters, as discussed above. In one embodiment, contention resolution schemes disclosed by D. J. Blumenthal, B. E. Olson, G. Rossi, T. E. Dimmick, L. Rau, M. Masanovic, O. Lavrova, R. Doshi, O. Jerphagnon, J. E. Bowers, V. Kaman, L. Coldren, and J. Barton, “All-Optical Label Swapping Networks and Technologies,” IEEE J. of Lightwave Technology 18, 2058-2075 (2000) may be implemented. The PBS network can operate with a relatively small number of control wavelengths (λ′₀, λ₀), since they can be shared among many data wavelengths. Furthermore, the PBS switch fabric can also operate with a single wavelength using multiple fibers; however, further details of this implementation are not disclosed herein.

The control bursts can be sent either in-band (IB) or out of band (OOB) on separate optical channels. For the OOB case, the optical data bursts are statistically switched at a given wavelength between the input and output ports within a variable time duration by the PBS fabric based on the reserved switch configuration as set dynamically by network processor 1902. NP 1902 is responsible to extract the routing information from the incoming control bursts, providing fix-duration reservation of the PBS switch resources for the requested data bursts, and forming the new outgoing control bursts for the next PBS switching node on the path to the egress node. In addition, the network processor provides overall PBS network management functionality based on then extended GMPLS-based framework discussed above. For the IB case, both the control and data bursts are transmitted to the PBS switch fabric and control interface unit. However, NP 1902 ignores the incoming data bursts based on the burst payload header information. Similarly, the transmitted control bursts are ignored at the PBS fabric since the switch configuration has not been reserved for them. One advantage of this approach is that it is simpler and cost less to implement since it reduces the number of required wavelengths.

Another approach for IB signaling is to use different modulation formats for the control bursts and the data bursts. For example, the control bursts are non-return to zero (NRZ) modulated while the data bursts are return to zero (RZ) modulated. Thus, only the NRZ control bursts are demodulated at the receiver in the PBS control interface unit while the RZ data bursts are ignored. The specific OOB or IB control-signaling scheme to be selected is application dependent.

Embodiments of method and apparatus for implementing a resource reservation schedules in a photonic burst switching network are described herein. In the above description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring this description.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable optical manner in one or more embodiments.

Thus, embodiments of this invention may be used as or to support software program executed upon some form of processing core (such as the CPU of a computer or a processor of a module) or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

In the foregoing specification, embodiments of the invention have been described. It will, however, be evident that various modifications and changes may be made thereto without departing from the broader spirit and scope as set forth in the appended claims. The specification and drawings are, accordingly, to be regarded in an illustrative rather than a restrictive sense.

1. A method for establishing a coarse-grained reservation of a lightpath traversing a plurality of connected lightpath segments between source and destination nodes in an optical switched network, comprising:
making a soft reservation of node resources supporting respective lightpath segments from among the plurality of lightpath segments, the soft reservation of the node resources corresponding to a scheduled time period for which the lightpath is requested to be reserved;
determining if adequate node resources are available for reservation during the scheduled time period to support traversal of the entire lightpath; and
making a hard reservation of the node resources corresponding to the scheduled time period if adequate node resources are determined to be available.

2. The method of claim 1, wherein the optical switched network comprises a photonic burst switched (PBS) network.

3. The method of claim 2, wherein the optical burst switched network comprises a wavelength-division multiplexed (WDM) PBS network.

4. The method of claim 1, further comprising storing resource reservation data at each node, including resource reservation status indicia indicating whether a resource has a corresponding soft or hard reservation.

5. The method of claim 4, further comprising:
passing a resource reservation request message between the nodes connected to the lightpath segments in a downstream traversal of the lightpath, the resource reservation request message including resource reservation information;
extracting the resource reservation information from the resource reservation request message;
determining, based on existing resource reservation data for a given node, whether adequate resources are available during the scheduled time period; and
making a soft reservation for a node resource the resource is determined to be available for the scheduled time period.

6. The method of claim 5, wherein the resource reservation request message includes a generalized multi-protocol label-switching (GMPLS)-based label defining transmission parameters for a lightpath segment to which the GMPLS-based label corresponds.

7. The method of claim 6, wherein the GMPLS-based label includes at least one field identifying an input wavelength employed for carrying signals over a lightpath segment identified by the GMPLS-based label.

8. The method of claim 5, wherein the resource reservation request message comprises a Path message having a format based on an extension to the RSVP-TE (ReSerVation Protocol-Traffic Engineering) signaling protocol.

9. The method of claim 5, wherein the resource request information includes data defining the scheduled time period.

10. The method of claim 5, further comprising:
passing a resource reservation response message between the nodes coupled to the lightpath segments in an upstream traversal of the lightpath, the resource reservation request message including resource reservation response information;
extracting, at each node, the resource reservation response information from the resource reservation response message; and
changing, at each node, the soft reservation for the node resource to a hard reservation.

11. The method of claim 10, wherein the resource reservation response message comprises a Resv message having a format based on an extension to the RSVP-TE (ReSerVation Protocol-Traffic Engineering) signaling protocol.

12. The method of claim 1, further comprising:
building a list of potential lightpaths between the source and destination nodes;
selecting a first potential lightpath in the list;
determining if sufficient resources are available to reserve node resources supporting lightpath segments defined by the first potential lightpath for the scheduled time period; and
processing a next potential lightpath in the list to determine if sufficient resources are available to reserve node resources supporting lightpath segments defined by the next lightpath for the scheduled time period if it is determined that resources supporting the lightpath segments of the first potential lightpath are insufficient; and
repeating the previous operation for subsequent next potential lightpaths in the list until either a lightpath having sufficient resources is identified or the list is exhausted.

13. The method of claim 12, further comprising prioritizing the potential lightpaths in the list based on at least one transmission-related criteria.

14. The method of claim 13, further comprising dynamically reprioritizing the potential lightpaths in the list in response to a detected change in network transmission conditions.

15. The method of claim 13, wherein the potential lightpaths are prioritized based on traffic balancing considerations.

16. The method of claim 13, further comprising dynamically reprioritizing the potential lightpaths in the list in response to a detected change in network topology.

17. The method of claim 12, wherein the determination of whether adequate resources are available at a given node comprises:
aggregating any existing reservations for the node resource corresponding to a specified bandwidth and the scheduled time period to obtain an existing resource allocation;
adding the bandwidth percentage corresponding to a resource reservation request to the existing resource allocation to obtain a requested allocation for the node resource;
determining if the requested allocation exceeds a threshold.

18. The method of claim 1, wherein a partial use of a node resource may be reserved.

19. The method of claim 18, wherein the partial use comprises a bandwidth percentage use of a lightpath segment.

20. A switching apparatus for use in an optical switched network, comprising:
optical switch fabric, having at least one input fiber port and at least one output fiber port; and
a control unit, operatively coupled to control the optical switch fabric, including at least one processor and a first storage device operatively coupled to said at least one processor containing machine-executable instructions, which when executed by said at least one processor perform operations, including:
receiving a resource reservation request from a first node, said resource reservation request including data pertaining to a first lightpath segment between the first node and the switching apparatus, which comprises a second node, and a scheduled time period for which resources for the switching apparatus are requested to be reserved; and
making a soft reservation of resources supporting communication via the first lightpath segment for the scheduled time period;
receiving a reservation response; and
changing the soft reservation of the resources supporting communication via the first lightpath segment to a hard reservation to commit the resources for the scheduled time period.

21. The switching apparatus of claim 20, wherein execution of the instructions further performs the operation of storing resource reservation data on one of the first storage device or a second storage device operatively coupled to said at least one processor, said resource reservation data including resource reservation status indicia indicating whether a resource has a corresponding soft or hard reservation.

22. The switching apparatus of claim 20, wherein the optical switched network comprises a photonic burst switched (PBS) network.

23. The switching apparatus of claim 22, wherein the optical switched network comprises a wavelength-division multiplexed (WDM) PBS network; and the optical switching fabric provides switching of optical signals comprising different wavelengths carried over common fibers that may be respectively coupled to said at least one input fiber port and said at least one output fiber port.

24. The switching apparatus of claim 20, wherein the resource reservation request message includes a generalized multi-protocol label-switching (GMPLS)-based label defining transmission parameters for the first lightpath segment.

25. The switching apparatus of claim 20, wherein the resource reservation request message comprises a Path message having a format based on an extension to the RSVP-TE (ReSerVation Protocol-Traffic Engineering) signaling protocol.

26. The switching apparatus of claim 20, wherein the resource reservation response message comprises a Resv message having a format based on an extension to the RSVP-TE (ReSerVation Protocol-Traffic Engineering) signaling protocol.

27. The switching apparatus of claim 20, wherein execution of the instructions further performs the operations of:
extracting a location of a third node coupled to the switching apparatus via a second lightpath segment from the resource reservation request; and
forwarding the resource reservation request to the third node.

28. The switching apparatus of claim 20, wherein execution of the instructions further performs the operations of:
determining if sufficient resources are available to support communication via the first lightpath segment for the scheduled timeframe; and
generating an error message if it is determined that there are not sufficient resources available.

29. The switching apparatus of claim 20, wherein said at least one processor includes a network processor.

30. The switching apparatus of claim 20, wherein said at least one processor further includes a control processor.

31. A machine-readable medium to provide instructions, which when executed by a processor in a switching apparatus comprising a first node in an optical switched network, cause the switching apparatus to perform operations comprising:
receiving a resource reservation request from a second node, said resource reservation request including data pertaining to a lightpath segment between the second node and the switching apparatus and a scheduled time period for which resources for the switching apparatus are requested to be reserved to support communication via the lightpath segment;
determining if resources are available to support communication via the lightpath segment during the scheduled time period, and if so,
making a soft reservation of resources supporting communication via the first lightpath segment for the scheduled time period;
receiving a reservation response; and
changing the soft reservation of the resources supporting communication via the first lightpath segment to a hard reservation to commit the resources for the scheduled time period.

32. The machine-readable medium of claim 31, wherein execution of the instructions further performs the operations of:
storing resource reservation data on a storage device operatively coupled to the processor, said resource reservation data including resource reservation status indicia indicating whether a resource has a corresponding soft or hard reservation.

33. The machine-readable medium of claim 31, wherein execution of the instructions determines whether adequate resources are available at a given node by performing operations including:
aggregating any existing reservations for the node resource corresponding to a specified bandwidth and the scheduled time period to obtain an existing resource allocation;
adding the bandwidth percentage corresponding to a resource reservation request to the existing resource allocation to obtain a requested allocation for the node resource; and
determining if the requested allocation exceeds a threshold.

34. The machine-readable medium of claim 31, wherein the optical switched network comprise a wavelength-division multiplexed (WDM) photonic burst switched (PBS) network.
